(19) United States
(12) Patent Application Publication
(10) Pub. No.: US 2007/0104188 A1
(43) Pub. Date: May 10, 2007

(54) Determining transmission latency in network devices

(76) Inventor: Zenon Kuc, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/268,419

(22) Filed: Nov. 7, 2005

(51) Int. Cl. H04L 12/56

(52) U.S. Cl. 370/389

(57) ABSTRACT

A method, system and storage medium for determining a transmission latency in a network device. The method includes receiving a plurality of data packets in the network device, determining a packet age value for each received packet, generating at least one latency value from a plurality of the determined packet age values; and determining the transmission latency of the network device based on at least one generated latency value. The system includes a processor subsystem adapted to determine a packet age value for each packet received in the network device, to generate at least one latency value from a plurality of the determined packet age values, and to determine the transmission latency of the network device based on at least one generated latency value. The storage medium provides software that, if executed by a computing device, will cause the computing device to perform the foregoing operations.

### FIELD

Embodiments of the invention relate to network devices. More particularly, embodiments of the present invention are directed to a system and method for computing transmission latencies in and between network devices.

### BACKGROUND

Computer networks, such as the Internet, are in wide-spread use today. These networks provide network devices, namely devices connected to the network such as personal computers, servers, or the like, with the ability to communicate with each other. Network devices communicate with each other by converting the data to be communicated into data packets and transmitting the packets across the network. In a typical network, however, a direct physical connection between two devices is often not possible due to the large number of devices using the network. As such, the packets may pass through several intermediate network devices such as routers, switches etc. which direct and help deliver the packets to their intended destination network device.

When large number of network devices are present in a network, at any given time immense numbers of packets may be in transit across the network. As such, the network may become congested at one or more points along the path of the data packets, most often at the switching or routing stations tasked with redirecting the packets. A delay at any given point can result in an overall delay, or latency, in the transmission time of a packet. This problem becomes particularly acute in case of time-sensitive transmissions of data, such as phone conversations or live video telecasts. It is therefore highly desirable for the location of such latencies to be determined quickly so that the latency can be effectively dealt with, such as by fixing the problems at the latency site or seeking alternate routes to bypass the latency site.

Unfortunately, existing methods do not adequately provide a solution to the foregoing problem. One widespread existing method is by use of utility software, such as PING, running on a CPU of a network device. In a typical scenario, the transmitting network device transmits a PING-packet to a recipient network which then returns the packet to the transmitting network device. The transmitting network device then compares the travel time of the PING-packet to a predetermined time threshold to determine if any latencies exits in the path. While methods such as PING are effective in determining the existence of a latency, they do not provide the location of the latency, such as a congested switch or router responsible for the latency so that the congested site(s) can be tended to, or bypassed, to reduce the overall latency in the transmissions.

Accordingly, there is a need to determine locations of transmission latencies for network devices along the transmission path of data packets in a network.

### SUMMARY OF THE INVENTION

This invention can be regarded as a method for determining transmission latency in a network device. The method includes receiving a plurality of data packets in the network device, determining a packet age value for each received packet, generating at least one latency value from a plurality of the determined packet age values; and determining the transmission latency of the network device based on at least one generated latency value.

This invention can also be regarded as a system to determine transmission latency in a network device. The system includes a processor subsystem adapted to determine a packet age value for each packet received in the network device, to generate at least one latency value from a plurality of the determined packet age values, and to determine the transmission latency of the network device based on at least one generated latency value.

This invention can also be regarded as a storage medium that provides software that, if executed by a computing device, will cause the computing device to perform the following operations: determining a packet age value for each received packet in a network device, generating at least one latency value from a plurality of the determined packet age values; and determining the transmission latency of the network device based on at least one generated latency value.

### BRIEF DESCRIPTION OF THE DRAWINGS

FIG. 1 is an exemplary network environment in which the present invention may be practiced.

FIG. 2 further illustrates a network device used in exemplary network environment shown in FIG. 1.

FIG. 3 is a flow chart illustrating the operations of an embodiment of the present invention.

FIGS. 4A-B further illustrate the operations of the present invention shown in FIG. 3.

FIG. 5 is a flow chart further illustrating the operations of an embodiment of the present invention shown in FIG. 3.

### DETAILED DESCRIPTION OF THE INVENTION

Embodiments of the invention generally relate to a system and method for computing transmission latencies between network devices. Herein, the invention may be applicable to a variety of wired and/or wireless networks such as a local area network (LAN), wide area network (WAN) such as the Internet and the like.

Certain details are set forth below in order to provide a thorough understanding of various embodiments of the invention, albeit the invention may be practiced through many embodiments other than those illustrated. Well-known logic and operations are not set forth in detail in order to avoid unnecessarily obscuring this description.

In the following description, certain terminology is used to describe features of the invention. For example, the term “network device” includes any device adapted to process data. Examples of network devices include, but are not limited or restricted to a server, computer, personal digital assistant (PDAs), voice-over-IP (VoIP) telephone, or the like. A “switching device” is any device adapted to transfer information received at an ingress port.

The term “software” generally denotes executable code such as an operating system, an application, an applet, a routine or even one or more instructions. The software may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVD”), a hard drive disk, tape, or any kind of interconnect (defined below).

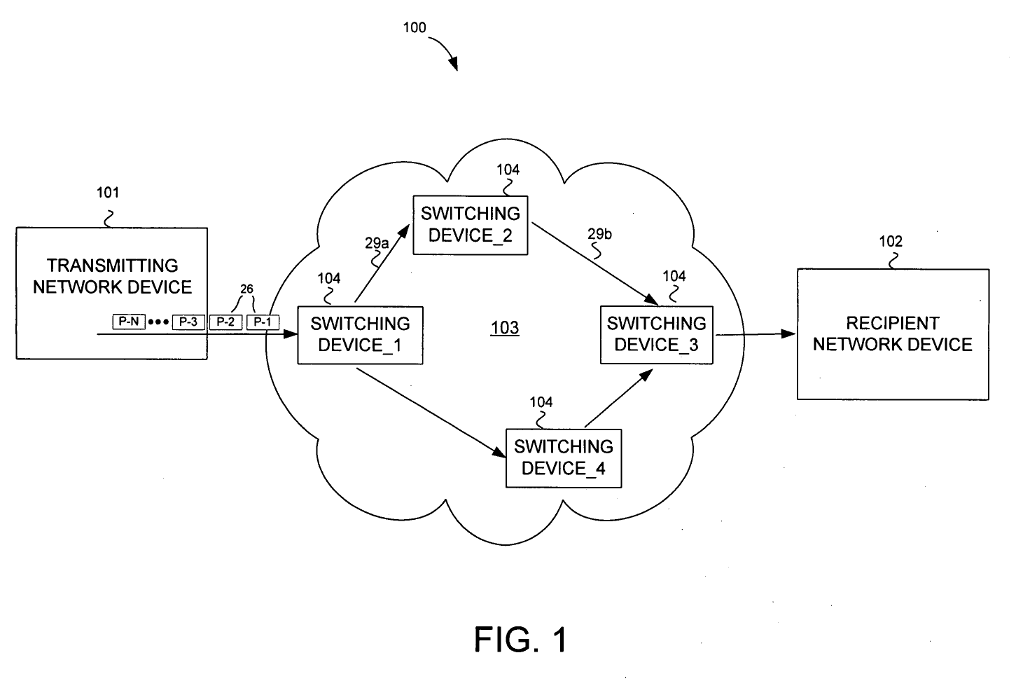

With reference to FIG. 1, an exemplary network environment 100 is shown in which the present invention may be practiced. As shown in FIG. 1, the network environment 100 includes a transmitting network device 101, such as a personal computer, which communicates with a recipient network device 102 via the network 103. As described above, the network devices 101 and 102 communicate with each other by converting the data to be communicated into data packets 26, such as data packets P-1 through P-N (N>1), and transmitting the data packets 26 across the network 103. In a typical network, such as the exemplary network 103, the data packets 26 may pass through several intermediate network devices such as switching devices 104, which direct and help deliver the packets to their intended destination network device, such as the recipient network device 102. For simplicity, only two network devices 101 and 102, and four switching devices 104 (switching device_1 through switching device_4) are shown in FIG. 1. In a typical network 103, at any given time immense numbers of data packets 26 from various transmitting network devices 101 are in transit across the network 103 and may cause congestion at one or more points along the path of the data packets 26, such as at any of the switching devices 104 tasked with redirecting the data packets 26. A delay at any given point can result in an overall delay, or latency, in the transmission time of a packet 26.

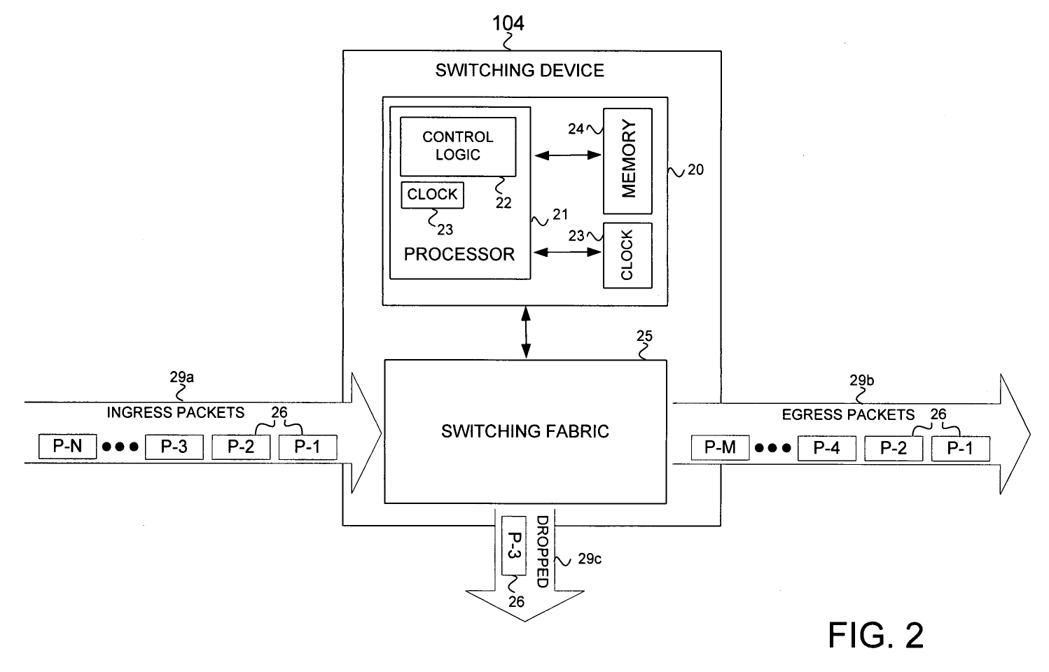

FIG. 2 illustrates an exemplary switching device 104, such as switching device_2 which receives the transmitted data packets 26 from switching device_1 and in turn transmits them to switching device_3 en-route to the recipient network device 102. For simplicity only one ingress path 29a into and one egress path 29b out of each switching device 104 are shown although it is understood that each switching device 104 may have numerous ingress and egress paths from and to numerous switching devices 104. As shown in FIG. 2, each switching device 104 further includes a processor subsystem 20 in communication with a switching fabric 25.

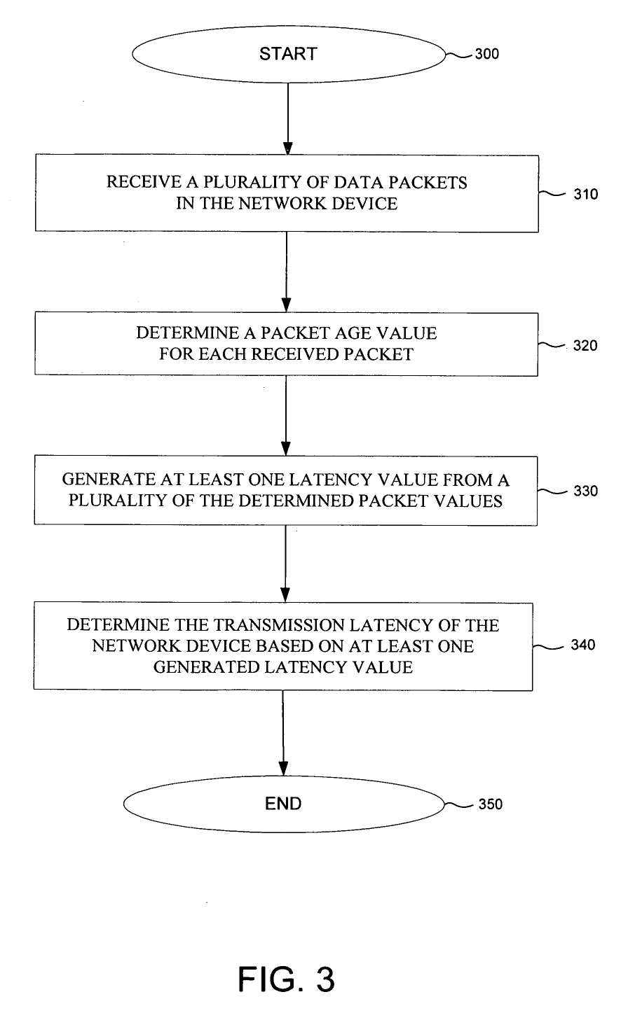

As described in greater detail in conjunction with FIGS. 3-5 below, the switching fabric 25 is adapted to receive data packets 26 via the ingress path 29a and based on instructions received from the processor subsystem 20 to either transmit data packets 26 via egress path 29b or to drop data packets 26, as symbolically represented by drop path 29c. The processor subsystem 20 comprises a processor 21 in communication with a memory 24 and a clock 23. The clock 23 may be external or internal to the processor 21 as shown in FIG. 2. The processor 21 further includes a logic control 22 configured to implement the latency determination functions ascribed to the switching device 104 as described below in conjunction with FIGS. 3-5.

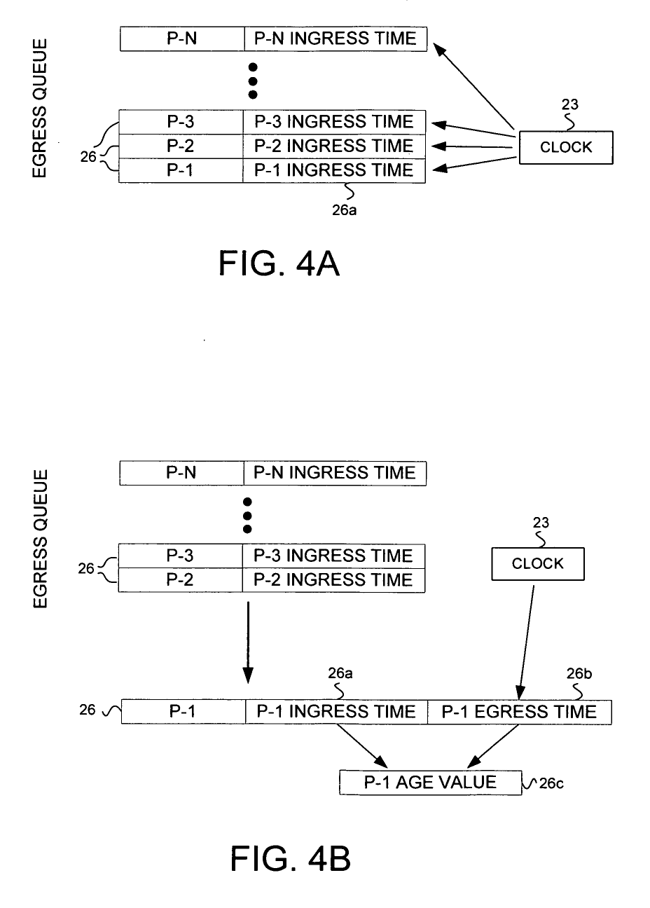

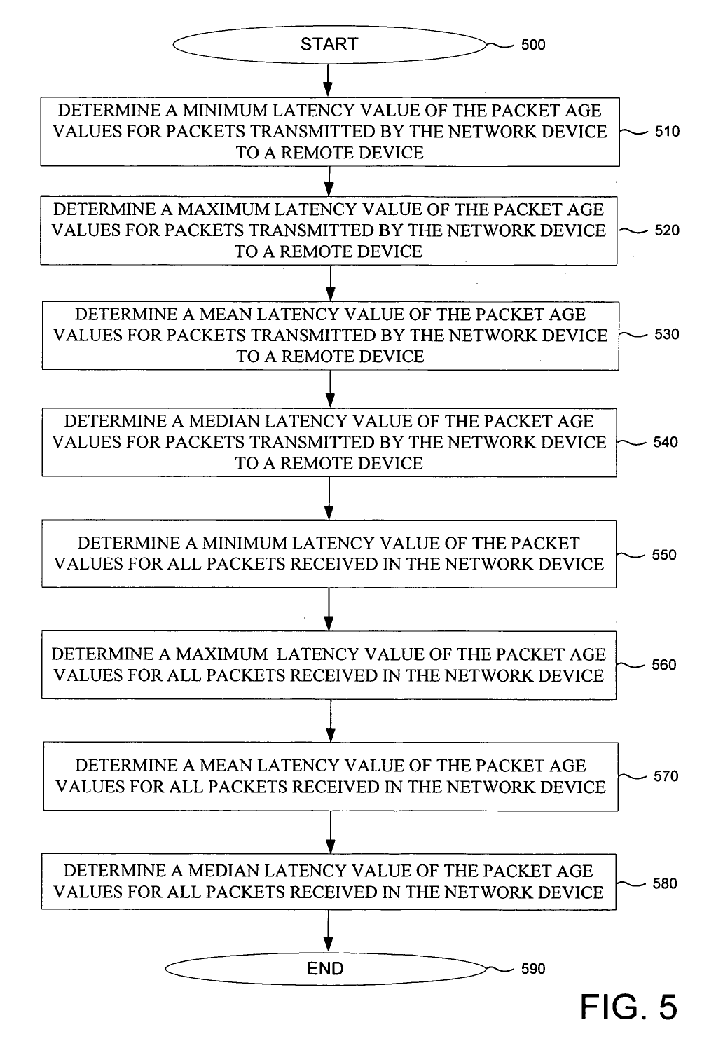

The overall series of operations of the present invention for determining a transmission latency of the switching device 104 will now be discussed in greater detail in conjunction with FIG. 3. As shown, the process begins in block 300 and proceeds to block 310 in which data packets 26 are received in the switching device 104, such as in the switching fabric 25 via path 29a. Next, in block 320, a packet age value is determined for each received data packet 26 as described in greater detail in conjunction with FIGS. 4A-B below. Next, in block 330 at least one latency value is generated from the determined packet age values as described below and in greater detail in conjunction with FIG. 5 below. Next, in block 340, the transmission latency of the switching device 104 is determined based on the latency values generated in block 330. The flow then proceeds to block 350 in which the overall process ends.

FIGS. 4A-B further illustrate the operations of block 320 of FIG. 3 for determining a packet age value for each of the received data packets 26. As shown in FIG. 4A, each of the received data packets 26 is time-stamped with an ingress time 26a by the clock 23, which corresponds to the time when each data packet 26 was received in the switching device 104. Next, as shown in FIG. 4B, when the time comes for each data packet 26 to egress the switching device 104, it is given an egress time 26b by the clock 23. The processor 21 is adapted to then determine an age value 26c for each data packet 26 by determining the time difference between the ingress time 26a and the egress time 26b. Next, if the age value 26c for a data packet 26 is less than a predetermined threshold, then the data packet 26 is transmitted via the egress path 29b, as shown in FIG. 2. If the age value 26c for a data packet 26 is not less than a predetermined threshold, then it is deemed that too long a time period has lapsed during the stay of the data packet 26 in the switching device 104 and therefore the data packet 26 is dropped, as symbolically represented by drop path 29c in FIG. 2. Suitably, the clock 23 used in conjunction with the present invention is adapted to provide a resolution corresponding to a clock having a precision of 32-bits or more when time-stamping the ingress time 26a and egress time 26b for each data packet 26.

FIG. 5 further illustrate the operations of block 330 of FIG. 3 for generating a latency value from the determined packet age values 26c of the data packets 26. As shown, the process begins in block 500 and proceeds to block 510 in which a minimum latency value is determined for the packet age values 26c that were transmitted by the switching device 104 via the egress path 29b. Next, in block 520, a maximum latency value is determined for the packet age values 26c that were transmitted by the switching device 104 via the egress path 29b. Next, in block, 530, a mean latency value is determined for the packet age values 26c that were transmitted by the switching device 104 via the egress path 29b. Next, in block 540, a median latency value is determined for the packet age values 26c that were transmitted by the switching device 104 via the egress path 29b. Next, in block 550, a minimum latency value is determined for the packet age values 26c that were either transmitted via the egress path 29b, or dropped by the switching device 104. Next, in block 560, a maximum latency value is determined for the packet age values 26c that were either transmitted via the egress path 29b, or dropped by the switching device 104. Next, in block 570, a mean latency value is determined for the packet age values 26c that were either transmitted via the egress path 29b, or dropped by the switching device 104. Next, in block 580, a median latency value is determined for the packet age values 26c that were either transmitted via the egress path 29b, or dropped by the switching device 104. The flow then proceeds to block 590 for returning to block 330 of FIG. 3. It should be noted that the foregoing process blocks 510 through 580 were described to provide a list of available process options to be used by the present invention in determining a transmission latency of the switching device 104, and that embodiments of the present invention may utilize all or only a selected subset of the above-described operations in determining a transmission latency of the switching device 104. Suitably, processor subsystem 20 is adapted to select a sample set of packet age values 26c and to perform the generating of a latency value from the selected sample set.

Returning to block 340 of FIG. 3, a transmission latency of the switching device 104 is then determined, such as in the form of a transmission latency value, based on the latency values generated in block 330 as described in conjunction with FIG. 5 above. Suitably, the memory 24 shown in FIG. 2 is adapted to store the transmission latency value associated with the transmission latency of the switching device 104. The switching device 104 is also suitably adapted to communicate the determined transmission latency of the switching device 104 to a remote source, such as to a user or another network device, such as by responding to a polling operation. Suitably, the storage medium of memory 24 provides the necessary software that, if executed by the processor subsystem 20, will cause the processor subsystem 20 to perform the foregoing operations described in conjunction with FIGS. 3-5. The storage medium may also be suitably implemented within the processor 21 of the processor subsystem 20.

One advantage of the foregoing feature of the present invention over the prior art is that by determining locations of transmission latencies for network devices along the transmission path of data packets in a network, more timely and effective approaches can be undertaken to reduce the latency in transmissions to a destination network device. For example, referring to FIG. 1, a transmitting network device 101 in an attempt to communicate with recipient network device 102, first transmits a series of data packets 26 such as P-1 through P-N to the switching device_1. The switching device_1 then determines that perhaps the optimal way to reach recipient network device 102 is through switching device_2 and switching device_3, respectively, and therefore forwards the data packets 26 to the switching device_2. The foregoing path to recipient network device 102, however, has suddenly become congested and using the prior art PING methods does not reveal the exact location of the congestion. By using the embodiments of the present invention, it can be determined that for example the switching device_2 is the source of the latency and efforts can be undertaken immediately to reduce the latency in transmission from the network device 101 to recipient network device 102. These efforts may include a) alleviating the congestion at the switching device_2 such as by notifying a system administrator of the switching device_2, or b) having the switching device_1 select another path that bypasses the switching device_2, such as going through the switching device_4 to reach the switching device_3 and the recipient network device 102.

It should be noted that the various features of the foregoing embodiments were discussed separately for clarity of description only and they can be incorporated in whole or in part into a single embodiment of the invention having all or some of these features.

What is claimed is:

1. A method for determining a transmission latency in a network device, the method comprising:
receiving a plurality of data packets in the network device;
determining a packet age value for each received packet;
generating at least one latency value from a plurality of the determined packet age values; and
determining the transmission latency of the network device based on at least one generated latency value.

2. The method of claim 1, the generating of the at least one latency value further comprising:
selecting a plurality of packet age values; and
generating the at least one latency value from the selected packet age values.

3. The method of claim 2, wherein the selecting a plurality of packet age values further comprising:
selecting a plurality of packet age values corresponding to received packets transmitted by the network device to a remote device.

4. The method of claim 1, wherein the at least one latency value comprises a minimum latency value of the plurality of the determined packet age values.

5. The method of claim 1, wherein the at least one latency value comprises a maximum latency value of the plurality of the determined packet age values.

6. The method of claim 1, wherein the at least one latency value comprises a mean latency value of the plurality of the determined packet age values.

7. The method of claim 1, wherein the at least one latency value comprises a median latency value of the plurality of the determined packet age values.

8. The method of claim 1, further comprising:
storing the determined transmission latency of the network device.

9. The method of claim 1, further comprising:
communicating the determined transmission latency of the network device to a remote source.

10. The method of claim 1, wherein the network device comprise a network switch.

11. A system to determine a transmission latency in a network device, the system comprising:
a processor subsystem adapted to determine a packet age value for each packet received in the network device, to generate at least one latency value from a plurality of the determined packet age values, and to determine the transmission latency of the network device based on at least one generated latency value.

12. The system of claim 11, wherein the processor subsystem is further adapted to select a plurality of packet age values, and to generate the at least one latency value from the selected packet values.

13. The system of claim 12, wherein the processor subsystem is further adapted to select a plurality of packet age values corresponding to received packet transmitted by the network device to a remote device.

14. The system of claim 11, wherein the at least one latency value comprises at least one of a minimum latency value, a maximum latency value, a mean latency value and a median latency value of the plurality of the determined packet age values.

15. The system of claim 11, wherein the processor subsystem comprises a processing unit and a memory implemented within the processing unit to store instructions for the processing unit to determine the transmission latency of the network device based on the at least one generated latency value.

16. The system of claim 11, further comprising:
a memory subsystem in communication with the processor subsystem and adapted to store the determined transmission latency of the network device.

17. The system of claim 11, further comprising:
a communication subsystem adapted to communicate the determined transmission latency of the network device to a remote source.

18. The system of claim 11, wherein the network device comprise a network switch.

19. A storage medium that provides software that, if executed by a computing device of a network device, will cause the computing device to perform the following operations:
determining a packet age value for each received packet in the network device;
generating at least one latency value from a plurality of the determined packet age values; and
determining the transmission latency of the network device based on at least one generated latency value.

20. The storage medium of claim 19, wherein the storage medium is implemented within a processing unit of the computing device.
